(19) United States
(12) Patent Application Publication
(10) Pub. No.: US 2006/0179902 A1
(43) Pub. Date: Aug. 17, 2006

(54) Lock with integral pump

(76) Inventor: Robert James Douglas Reeves, Toronto (CA)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/334,807

(22) Filed: Jan. 18, 2006

(30) Foreign Application Priority Data
Jan. 19, 2005 (CA) 2,493,268

(51) Int. Cl. B62H 5/00; E05B 71/00

(52) U.S. Cl. 70/233

(57) ABSTRACT

A lock with integral pump, comprising: a shackle, the shackle having a first end and a side portion displaced from the first end, the first end including a locking means; a hollow cylinder; a lock barrel at a first end of the hollow cylinder, the lock barrel being adapted to engage locking means in the first end of the shackle; a piston slidable within the hollow cylinder, the piston being adapted to engage the side portion of the shackle; and an air passage located within the hollow cylinder, wherein, in a lock position, the shackle and the hollow cylinder form an enclosed area by engaging the first end with the lock barrel and the side portion with the piston, and in a pump position the side portion is used to push and pull the piston within the hollow cylinder, thereby forcing air through the air passage.

### FIELD OF THE INVENTION

The present invention relates to a bicycle lock design having a combination of a locking and a pumping feature and, more specifically, to a design in which the shackle of the lock becomes the shaft for the pump.

### BACKGROUND TO THE INVENTION

Bicycles are popular for recreation, exercise and transportation. Bicycles can be ridden over a long or short distance but, regardless, a typical bicycle user will normally carry a number of accessories. These include, but are not limited to, a bicycle lock, a pump, spare tubes, tools for replacing tires and fixing general items, and water.

Each of the above-listed accessories takes up space on the bicycle and further adds weight to the bicycle. On a bicycle, space is often at a premium. To find a good location for all of the accessories can be difficult and can preclude the addition of other accessories if all of the areas for mounting the accessories are taken up. Further, each of the above items adds weight which would be reduced if the items were somehow combined. There is also the problem of locking up additional items that are carried on a bicycle.

Attempts in the past have been made overcome the above deficiencies. U.S. Pat. No. 5,216,902 to Gideon teaches a combination bicycle pump and lock. As illustrated in FIG. 2 of the Gideon reference, a U-shaped shackle is affixed to a lock means at one end and a handle at the other end. When U-shaped shackle is detached from handle and lock means a pump is created. The pump has a piston rod that is generally in an inserted configuration within cylinder but can be retracted from cylinder and used as the shaft for a pump when a pump is required.

One problem with Gideon is the lack of synergy between the shackle and the bicycle pump. Essentially, the two are individual components that are merely placed into an abutting position in order to save some space. The weight of the rod is added to the weight of the remainder of the pump and U-shaped shackle. Further, the cylinder is not hollow when the shaft is in its compressed configuration.

A further patent that attempts to solve the above problems is U.S. Pat. No. 3,922,894 to Johnson. Johnson teaches a storage cable for locking bicycles, motorcycles and the like, formed of a series of hollow tubes and short lengths of flexible steel cable connected together where part of the hollow steel tubes can be used for pumping. A problem with Johnson is that it is not applicable to U locks. There is no pivot between the two elements in that concept (the tube and the pump shaft/shackle or cable), which are required to create the strong and compact form of a U-lock. In addition, a “removable cap end” which is locked in position by the shackle and retains the piston when the lock is secured, allowing for service and storage when the lock is open, would not be possible in Johnson style tube/cable lock.

### SUMMARY OF THE INVENTION

The present invention seeks to overcome the deficiencies of the prior art by providing a combination of lock and pump where the shackle of the lock becomes the piston rod of the pump.

The configuration of the present invention provides a number of advantages over the prior art. The synergy between the shackle and the pump in the present invention causes the shackle to be used for both the lock purpose and for the pump purpose. This saves the weight of having a separate piston rod. Further, because the shackle is used as a piston rod and is out of the pump cylinder during normal operation, the pump cylinder remains hollow and can be used for storage purposes.

Other advantages of the present configuration include the use of pump O-rings or similar seals in the piston which would be standard in a piston but which also keep the inside of the chamber dry when the combination lock and pump is exposed to water.

In one configuration of the present invention, the shackle is connected to the piston of the pump using a piston pin where the shackle can rotate about the piston pin. This provides the advantage of having a lock that is already fitted at one end and, thus, only the lock end needs to be rotated into place. This prevents fiddling with the shackle and cylinder to join the two together. The other advantage of this lock is the synergy between the shackle and the end cap. When you rotate the shackle to secure the lock at the locked end, the cap is locked in place at the other end by the shackle while the cap retains the unsecured end of the shackle. Unlocking the lock and rotating the shackle frees up the end cap and allows the shackle to be removed for service and access to the storage area.

Other advantages and configurations will be evident to those skilled in the art with reference to the following drawings.

The present invention therefore provides a lock with integral pump, comprising: a shackle, said shackle having a first end and a side portion displaced from said first end, said first end including a locking means; a hollow cylinder; a lock barrel at a first end of said hollow cylinder, said lock barrel being adapted to engage locking means in said first end of said shackle; a piston slidable within said hollow cylinder, said piston being adapted to engage said side portion of said shackle; and an air passage located within said hollow cylinder, wherein, in a lock position, said shackle and said hollow cylinder form an enclosed area by engaging said first end with said lock barrel and said side portion with said piston, and in a pump position said side portion is used to push and pull said piston within said hollow cylinder, thereby forcing air through said air passage

### BRIEF DESCRIPTION OF THE DRAWINGS

The present invention will be better understood with reference to the drawings in which:

FIG. 1 is a side elevational view of the combination lock and pump according to one embodiment of the present invention;

FIG. 2 is a cross-sectional view of the cylinder according to the present invention;

FIG. 3 shows a front elevational view of a combination lock and pump in a pump configuration;

FIG. 4 shows the combination lock and pump 10 in a lock configuration;

FIG. 5 shows an exploded view of the combination lock and pump in a pump configuration;

FIG. 6 shows an example of an end cap;

FIG. 7a shows a first configuration for a first end of a shackle having a first corner configuration;

FIG. 7b shows an alternative configuration for a shackle and having rounded corners;

FIG. 8 shows an exploded view of a piston guide ring and assembly;

FIG. 9a shows a cap guide in an open position;

FIG. 9b shows a cap guide in a retaining position; and

FIG. 10 shows an optional tool for a slot in the pump tube.

### DETAILED DESCRIPTION OF THE DRAWINGS

Reference is now made to the drawings.

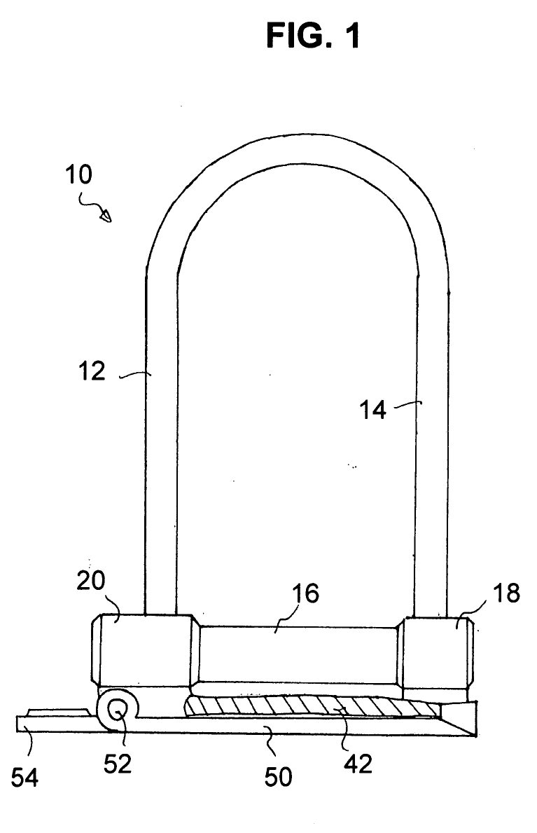

FIG. 1 shows a combination bicycle lock and pump in a closed position as used for locking. A shackle 12 forms a U- or a D-shape, depending on the application of the lock. Shackle 12 includes a side portion 14 that is straight and sufficiently long to fit within a cylinder 16. Alternatively, the locking end of shackle 12 could include a cable style lock fitted to its end, the cable style lock engaging a pin slid through a hole in the end of the tube.

In a preferred embodiment, shackle 12 is comprised of a hardened steel with a protective plastic or polymer coating over the hardened steel. However, as will be appreciated by those skilled in the art, other materials could be used for shackle 12.

Cylinder 16 has an end cap 18 to which a shackle 12 is connected and a second locking end 20 to which the other end of shackle 12 is connected.

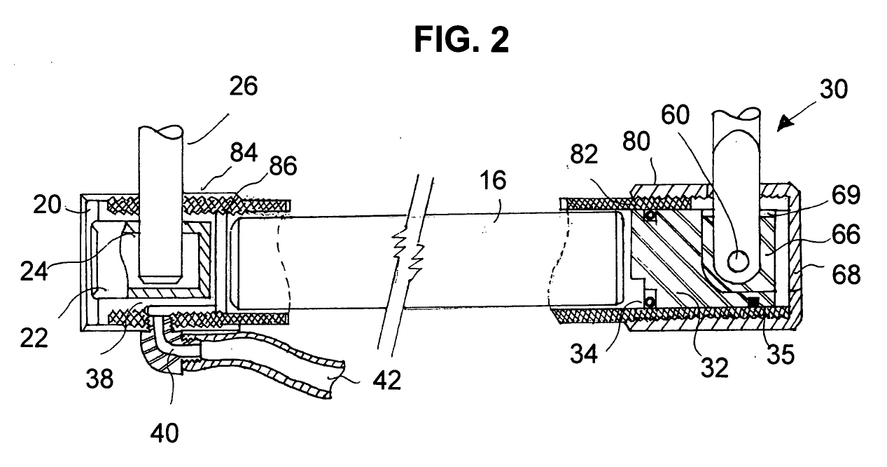

Reference is now made to FIG. 2.

FIG. 2 shows a cross-sectional view of cylinder 16. As is seen in FIG. 2, lock end 20 comprises a lock barrel 22 that includes a key insert (not shown). Lock barrel 22 has an opening 24 in one side thereof in order to accommodate a lock end 26 of shackle 12. Lock end 26 preferably includes a groove or cut-out to engage lock barrel 22 when lock barrel 22 is in a locked position. Other configurations will be known to those skilled in the art.

In order to provide a pump, FIG. 2 shows that the combination lock and pump 10 further includes a piston 30. Piston 30 includes piston packing 32, piston rings 34, and a piston rod which is the side portion 14 of shackle 12.

The other end of cylinder 16, in addition to being used for a lock barrel 22, includes an air passage 38 and a hose attachment 40. A hose 42 is attached to hose attachment 40 and includes a head adapted to fit over the air valve of a tire.

A divider preferably exists between lock chamber 22 and cylinder 16 to provide for better air tightness. This divider may be fitted to cylinder 16 or lock end 20.

In an alternative embodiment, hose 40 can tap into cylinder 16 directly, rather than providing an air passage 38 around the lock. This could in some cases simplify construction of the combination air pump and lock.

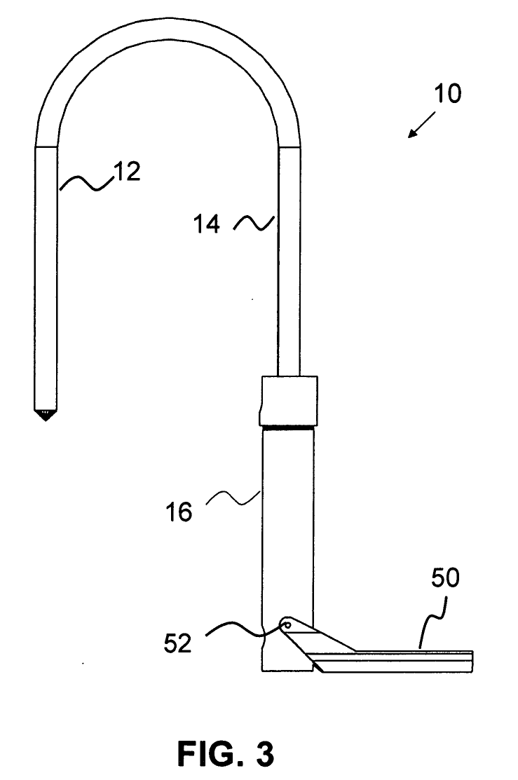

Reference is now made to FIG. 3.

FIG. 3 shows the combination lock and pump 10 in a pump configuration. A side portion 14 of shackle 12 is adapted to fit within cylinder 16 and is used as a piston shaft. With reference to FIG. 2, pressing down on shackle 12 will cause side portion 14 to travel into cylinder 16 thereby causing piston packing 32 to proceed along cylinder 16 and force air into hose attachment 40 and hose 42.

Preferably, a one-way valve exists along hose attachment 40 to ensure that air flows out of hose attachment 40 but does not flow back into cylinder 16 when shackle 12 is retracted from cylinder 16.

In a preferred embodiment, combination lock and pump 10 includes a foot pedal 50 used to steady the apparatus when in a pumping position. A pivot point 52 is used to rotate foot pedal 50 into alignment with the ground as seen in FIG. 3 to steady the combination lock and pump during pumping.

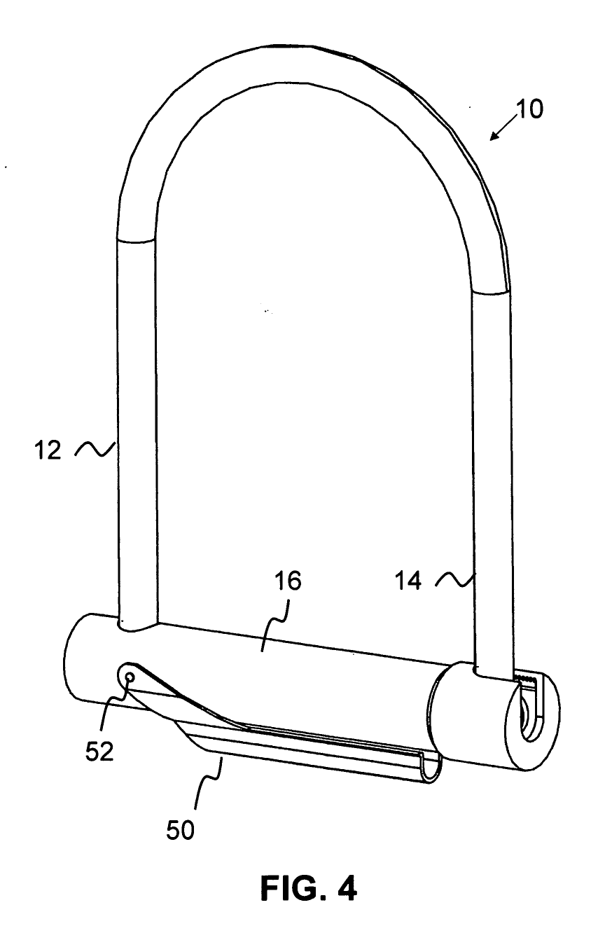

Reference is now made to FIG. 4.

FIG. 4 shows the combination lock and pump 10 in a lock configuration. Foot pedal 50 when not in use can be pivoted using pivot point 52 to be adjacent to cylinder 16 and thereby, out of the way. Further, air hose 42 can be tucked between foot pedal 50 and cylinder 16 in order to protect air hose 42.

In one embodiment of the present invention, foot pedal 50 can further include a cap 54 that is used to cover lock barrel 22 when foot pedal 50 is deployed. As will be realized by reference to FIG. 3, in a pumping mode, lock barrel 22 will be placed against the ground. If the ground is muddy or has other particles, this could block the lock mechanism of lock barrel 22 which would be undesirable. Cap 54 thereby protects lock barrel 22 from these contaminants.

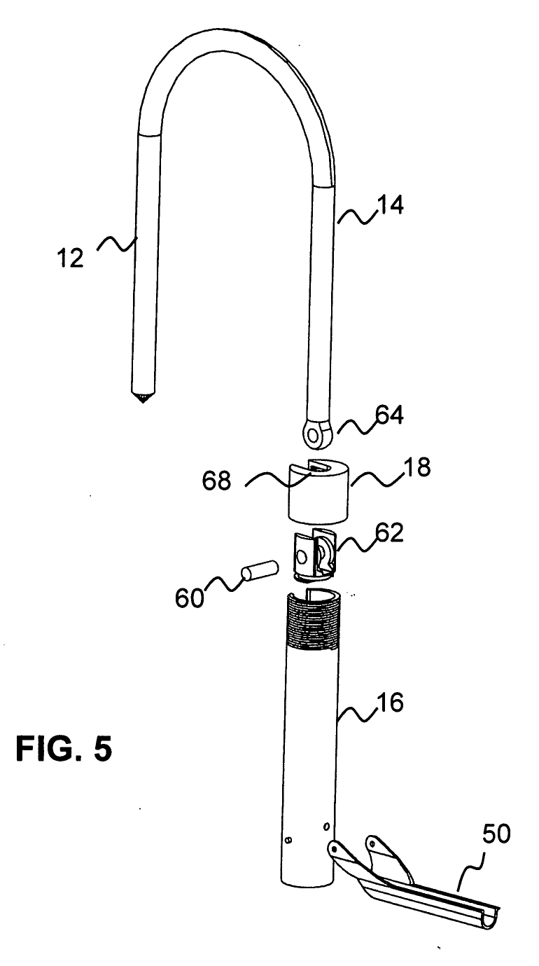

In a preferred embodiment, shackle 12 and cylinder 16 are connected through a pivot mechanism as is seen with reference to FIGS. 2 and 5. A side portion 14 of shackle 12 is preferably connected to cylinder 16 through a pivot pin 60. This allows cylinder 16 and shackle 12 to always be connected and facilitates the locking of shackle 12 to cylinder 16 through lock barrel 22 by merely pivoting cylinder 16 onto shackle 12. First end cap 18 includes a connection point 62 for connecting pivot pin 60 to side portion 14 of shackle 12. First end 14 includes a cylindrical opening 64 to further accommodate pivot pin 60.

In an alternative configuration, a ball and socket joint could be used between shackle 12 and cylinder 16.

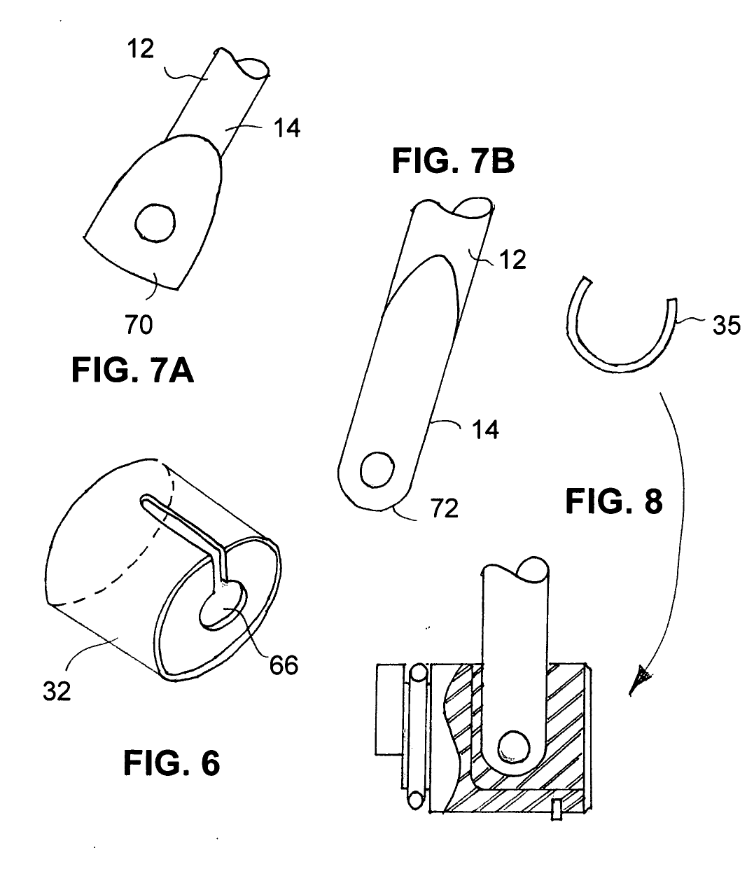

Reference is now made to FIG. 6.

FIG. 6 shows an example of end cap 18 that is also used to accommodate the pivoting of a side portion 14 of shackle 12. A groove 68 is included within end cap 18 to allow shackle 12 to be oriented either along the axis of travel of packing 32 or orthogonal to the axis of travel end capl8. A similar slot 66 exists in piston packing 32, as is best seen in FIG. 2 and a slot 69 exists in cylinder 16 corresponding with groove 68 of end cap 18.

Alternatively, as would be appreciated by one skilled in the art, piston packing 32 could be spherical and thereby able to rotate within cylinder 16. Shackle 12 in this alternative configuration could be rigidly affixed to spherical piston packing 32 and could be oriented by rotating the combined piston and shackle 12.

Reference is now made to FIG. 7.

FIG. 7a shows a first configuration for first end 14. In the first configuration, shackle 12 includes a head 70 with elongated corners. (elongated corners do not provide any function but show how end may look after forming) Alternatively, in FIG. 7b, more rounded corners 72 provide for ease of rotation of first end 14 of shackle 12.

Reference is now made to FIG. 8.

FIG. 8 shows an exploded view of piston guide ring 35 around a first end of piston packing 32. Due to groove 66, guide ring 35 provides an open side to allow the rotation of shackle 12 through guide ring 35. Alternatively, a low friction strip could be used in place of guide ring 35. Referring again to FIGS. 1 and 2, it will be appreciated by those skilled in the art that cylinder 16 remains hollow when the combination lock and pump 10 is in its lock configuration. Unlike the Gideon patent described above, in which the cylinder is occupied by a piston shaft, the present cylinder 16 is hollow thereby providing a weight advantage and further providing for storage. One advantage to the present invention is that items such as a bicycle tube and tools to replace a tire tube can be stored within the cylinder 16 when the combination lock and pump 10 is in its lock configuration. An inner storage tube with a lid can be used further protect or contain the items stored within the cylinder 16.

In order to accommodate the above, first end 18 includes threads 80 which are adapted to engage with threads 82 of cylinder 16 and thereby allow cylinder 16 to be screwed onto and off of first end 18. Similarly, lock cap 20 can include threads 84 which are adapted to engage with threads 86 of cylinder 16 and thereby allow the lock end to be removed from cylinder 16. Alternatively, lock cap 20 can be permanently affixed to cylinder 16, thereby eliminating the need for threads 86.

As will be appreciated by those skilled in the art, end cap 18 can only be unscrewed when lock end 26 is disengaged from lock barrel 22. This provides for security and ensures that the lock mechanism cannot be circumvented by unsecuring the cap.

In operation, a user could unscrew either lock end 20 or first end cap 18 to gain access to cylinder 16. Items such as tubes or tools could then be inserted into cylinder 16 and the cap 18 or 20 replaced. The user could then use the lock pump combination in its lock configuration as one would normally use a lock on a bicycle. Specifically, lock barrel 22 could be used to engage a key for unlocking lock end 26, cylinder 16 could then be pivoted on pivot pin 60 and a lock could be removed from its locking position or engaged into a locking position around the bicycle frame and wheel.

If the user gets a flat tire, combination lock and pump 10 could be transformed into its pumping configuration as seen in FIG. 3 where foot pedal 50 is rotated away from shaft 16 and preferably, cap 54 covers lock barrel 22. Hose 42 is thereby accessible. Further, shackle 12 rotates until the axis of first end 14 is in alignment with the longitudinal axis of cylinder 16. If there is any material stored within cylinder 16, it must be removed prior to any pumping. This could include the replacement tire tube and the tools needed to replace the tube on the wheel. A user could then affix hose 42 to the valve of the tire tube and pump by depressing first end 14 into cylinder 16. This causes piston packing 32 to proceed into cylinder 16 forcing air through hose attachment 40 and into hose 42.

In a further alternative embodiment of the present invention, an additional rotating element 90 could be added to the end of first end cap 18 of cylinder 16. This rotating element 90 could be rotated out to retain shackle 12 when used as a pump shaft. Rotating element 90 includes a slot that matches the slot of cap 18 and rotates around 180 degrees to create a round hole. Thus, instead of a slot, first end 14 of shaft 12 proceeds through a hole and this helps to guide the pump shaft and keep it in line.

In a further alternative embodiment, hole 24 of lock barrel 22 could be adapted to be an open-ended wrench for use as a bicycle tool. A nut that needs to be removed could be inserted into this hole and the hole be adapted to fit around the nut. Further, various inserts could be used for different-sized nuts. In order to protect the thread, a first insert may also be used instead of having hole 24 adapted to directly connect to a nut. Inserts that enable sockets and other bits can also be used.

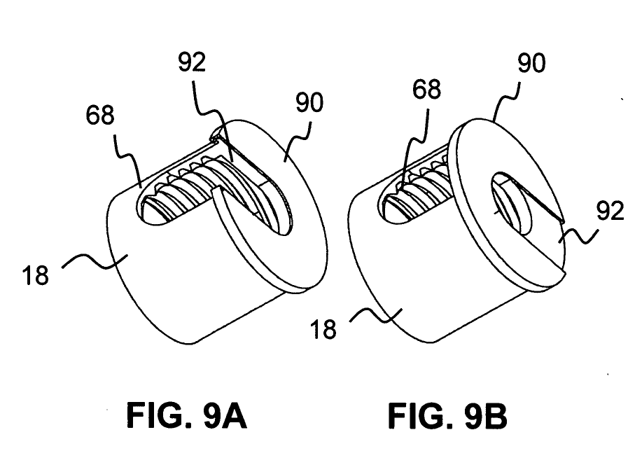

Reference is now made to FIGS. 9a and 9b.

End cap 18 could further optionally include a guide 90 rotatably positioned at one end thereof. Guide 90 is preferably a circular disc with a slot 92 extending from a central point to the periphery of guide 90. The guide would, in a lock operation, be rotated so that slot 92 lines up with slot 68, allowing first end 14 of shackle 12 to pivot. This allows the lock to be removed or attached, and further allows shackle 12 to become a piston rod.

Guide 90 can further be rotated to a retaining position as is best seen in FIG. 9b. In this position, guide 90 uses slot 92 as a retaining means and guide for shackle 12 while shackle 12 is being used as a piston rod. This prevents shackle 12 from pivoting when in the fully extended position of the pump.

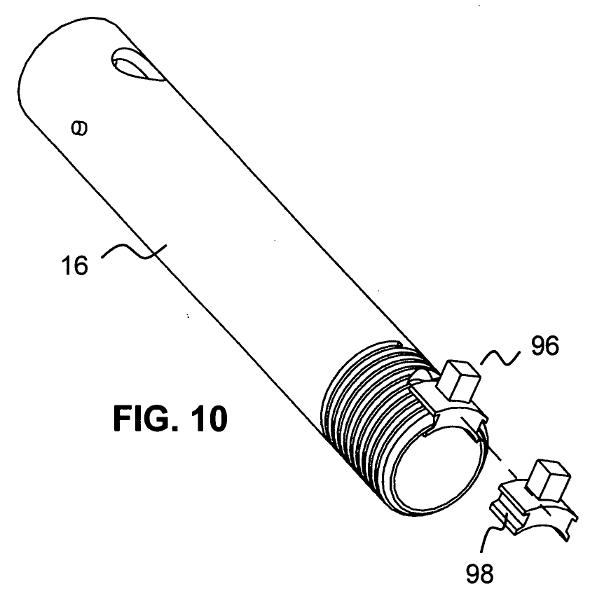

Reference is now made to FIG. 10.

In a further alternative embodiment of the present invention, slot 69 at the end of cylinder 16 could be adapted to be used for a tool. Specifically, as seen in FIG. 10, a screwdriver, socket driver, allen key or other tool 96 could be inserted into slot 69 and retained in place by grooves 98 in tool 96, or alternatively by friction fit. Various tools could thereby be carried compactly within cylinder 16.

As will be appreciated by one skilled in the art, cylinder 16, lock barrel 22 and cap 18 is preferably made of hardened steel with a plastic or polymer outing coating for protection. Piston packing 32 is preferably a rubber compound, as is hose 42. However, this is not meant to be limiting and other materials could be used as will be appreciated by those skilled in the art.

The above is meant to be illustrative of embodiments of the present invention and shows various ways of accomplishing the present invention. It is not, however, meant to be limiting and the only limitation to the scope of the present invention is found in the claims herein.

We claim:

1. A lock with integral pump, comprising:
a shackle, said shackle having a first end and a side portion displaced from said first end, said first end including a locking means; a hollow cylinder; a lock barrel at a first end of said hollow cylinder, said lock barrel being adapted to engage locking means in said first end of said shackle;
a piston slidable within said hollow cylinder, said piston being adapted to engage said side portion of said shackle; and
an air passage receiving air pumped by said piston,
wherein, in a lock position, said shackle and said hollow cylinder form an enclosed area by engaging said first end with said lock barrel and said side portion with said piston, and in a pump position said side portion is used to push and pull said piston within said hollow cylinder, thereby forcing air through said air passage.

2. The lock with integral pump of claim 1, wherein said side portion is pivotally connected to said piston.

3. The lock with integral pump of claim 1, wherein the piston is a sphere, said side portion being rigidly fastened to said sphere and said sphere being rotatable within said cylinder.

4. The lock with integral pump of claim 1, wherein said hollow cylinder includes a cap at affixed at a second end of said hollow cylinder along a first side of said cap.

5. The lock with integral pump of claim 4, wherein said cap includes a slot in an outer surface thereof, said slot being adapted to allow said side portion to pivot between the lock position and the pump position.

6. The lock with integral pump of claim 5, wherein said cap includes a guide at a second side of said cap, said guide allowing pivoting of said side portion when in the lock position, and rotatable to prevent pivoting of said side portion when in the pump position.

7. The lock with integral pump of claim 1, wherein said air passage includes a one-way valve to prevent air from entering said hollow cylinder.

8. The lock with integral pump of claim 1, further comprising a foot pedal, said foot pedal being pivotally connected to said hollow cylinder and adapted to fold against said hollow cylinder when in the lock position and perpendicular to said hollow cylinder when in the pump position.

9. The lock with integral pump of claim 8, wherein said foot pedal further includes a lock cover, the lock cover covering a key slot in said lock barrel when in the pump position

10. The lock with integral pump of claim 1, further comprising a hose connectable to said air passage.

11. The lock with integral pump of claim 1, wherein said hollow cylinder provides storage when in the lock position.

12. The lock with integral pump of claim 1, wherein said piston includes:
piston packing; and
piston rings to engage an inner side of said hollow cylinder.

13. The lock with integral pump of claim 12, wherein said piston further includes a slot allow said side portion to pivot from the lock position to the pump position.

14. The lock with integral pump of claim 13, wherein said piston further includes an open guide ring at a distal end of said piston from said piston rings, said open guide ring adapted to contact said inner surface of said hollow cylinder but not obstruct said slot in said piston.

15. The lock with integral pump of claim 13, wherein said piston further includes a low friction strip at a distal end of said piston from said piston rings, said low friction strip adapted to contact said inner surface of said hollow cylinder but not obstruct said slot in said piston.

16. The lock with integral pump of claim 1, wherein said hollow cylinder further includes a groove at the second end of the hollow cylinder, the groove capable of supporting a tool inserted therein.
